(19) United States
(12) Patent Application Publication
(10) Pub. No.: US 2026/0192787 A1
(43) Pub. Date: Jul. 9, 2026

(54) Independent Redundant Wheel Speed Processing System and Method

(71) Applicant: Wuhu Bethel Electronic Control System Co., Ltd., Wuhu (CN)

(72) Inventors: Lin HAN, Anhui (CN); Fen XU, Anhui (CN); Liquan WU, Anhui (CN)

(73) Assignee: Wuhu Bethel Electronic Control System Co., Ltd., Wuhu (CN)

(21) Appl. No.: 19/553,224

(22) Filed: Feb. 28, 2026

Related U.S. Application Data
(63) Continuation-in-part of application No. PCT/CN2024/107613, filed on Jul. 25, 2024.

(30) Foreign Application Priority Data
Aug. 31, 2023 (CN) 2023111243059

(51) Int. Cl. B60T 8/88; B60T 17/22

(52) U.S. Cl. CPC B60T 8/885; B60T 17/22; B60T 2270/406; B60T 2270/416

(57) ABSTRACT

An independent redundant wheel speed processing system is provided. The system includes four wheel speed sensors respectively disposed on four wheels and four wheel speed signal processing units. The four wheel speed sensors are respectively in communication with an MCU through the four wheel speed signal processing units. Each of the four wheel speed signal processing units diagnoses drive abnormalities and wheel speed signal abnormalities of one of the four wheel speed sensors, and sends diagnostic results to the MCU. The present disclosure ensures the functional safety and redundancy requirements of the braking system by providing independent and discrete wheel speed signal processing units, while also reducing the high costs incurred by using highly integrated chips to fulfill these requirements.

### CROSS REFERENCE TO RELATED APPLICATION

This application is a continuation-in-part application of International Application No. PCT/CN2024/107613, filed on July 25, 2024, which claims priority to a Chinese Patent Application No. CN2023111243059, filed on August 31, 2023. All the above are hereby incorporated by reference in their entireties for all purposes.

### FIELD OF THE DISCLOSURE

The present disclosure relates to the field of vehicle control technology, and more specifically, to an independent redundant wheel speed processing system and method.

### BACKGROUND OF THE DISCLOSURE

Vehicle’s brake controller needs to detect wheel speed signals from four wheel speed sensors to enable a braking system to perform driving brake control, parking brake control, and vehicle stability control functions. After processing and monitoring the input signals, each sub-function module calculates the wheel speeds, vehicle speed, and slip ratio based on the processed signals, then outputs the results to drive brake actuators and control other actuators through signals.

To comply with functional safety standards, wheel speed sensor detection circuits in the brake controller are required to satisfy specific diagnostic coverage and hardware failure rate criteria. For vehicles equipped with autonomous driving functions, the braking systems must incorporate functional redundancy, and thus, wheel speed sensors should also be designed with redundancy.

The current design employs highly integrated wheel speed acquisition chips, each configured to collect signals from four wheel speed sensors. However, a failure of a single chip may lead to the loss of signals from all four connected sensors. To ensure functional redundancy, each vehicle is equipped with two acquisition chips and a total of eight wheel speed sensors—two per wheel, as illustrated in FIG. 1. While this design adds hardware to ensure functional safety and redundancy, it also considerably increases the overall cost of the vehicles' braking systems.

### SUMMARY OF THE DISCLOSURE

The present disclosure provides an independent redundant wheel speed processing system and method.

The independent redundant wheel speed processing system includes four wheel speed sensors respectively disposed on four wheels and four wheel speed signal processing units.

The four wheel speed sensors are respectively in communication with an MCU through the four wheel speed signal processing units.

Each of the four wheel speed signal processing units diagnoses drive abnormalities and wheel speed signal abnormalities of one of the four wheel speed sensors, and transmits diagnostic results as well as valid wheel speed signals output by the one of the wheel speed sensors to the MCU.

Furthermore, each of the four wheel speed signal processing units includes a drive diagnostic module which diagnoses the drive abnormalities of the one of the wheel speed sensors. The drive diagnostic module includes a high-side drive diagnostic submodule and a low-side drive diagnostic submodule.

The high-side drive diagnostic submodule is connected to a high side of the one of the wheel speed sensors and communicates with the MCU. The high-side drive diagnostic submodule performs a high-side drive fault diagnosis on the one of the wheel speed sensors based on a high-side voltage.

The low-side drive diagnostic submodule is connected to a low side of the one of the wheel speed sensors through an acquisition circuit. The low-side drive diagnostic submodule performs a fault diagnosis on output signals of the one of the wheel speed sensors based on the acquisition circuit. The acquisition circuit and a power supply circuit are independently connected to the one of the wheel speed sensors. The power supply circuit provides power to the one of the wheel speed sensors, and the acquisition circuit acquires wheel speed signals.

Furthermore, the low-side drive diagnostic submodule includes a wheel speed open-circuit fault diagnosis unit and a wheel speed overcurrent fault diagnosis unit. The wheel speed open-circuit fault diagnosis unit and the wheel speed overcurrent fault diagnosis unit communicate with the acquisition circuit and perform fault diagnosis on the output signals of the one of the wheel speed sensors based on a low-side current signal acquired by the acquisition circuit. When a low-side current remains below 2 mA for at least 200 ms, a wheel speed open circuit is determined, thereby diagnosing a wheel speed open-circuit fault in the one of the wheel speed sensors. When the low-side current remains above 40mA for at least 200 ms, a wheel speed overcurrent is determined, thereby diagnosing a wheel speed overcurrent fault in the one of the wheel speed sensors.

The independent redundant wheel speed processing system further includes an ADC sampling circuit on a high-side of each of the wheel speed sensors to sample an ADC value of a voltage of the wheel speed sensor. The high-side drive diagnostic submodule communicates with the ADC sampling circuit to acquire the sampled ADC value and determines an operating voltage corresponding to the sampled ADC value. The high-side drive diagnostic submodule acquires a reference voltage from the MCU to verify with the operating voltage, thereby determining whether the operating voltage of the wheel speed sensor falls within a valid operating voltage range. Upon the operating voltage of the wheel speed sensor being within the valid operating voltage range, a high-side drive of the wheel speed sensor is deemed to be normal.

Furthermore, each of the wheel speed signal processing units includes a wheel speed diagnostic module which diagnoses the wheel speed signal abnormalities. An ADC acquisition circuit is provided at a wheel speed pulse input interface and communicates with the wheel speed diagnostic module. The ADC acquisition circuit acquires wheel speed pulse signals from the one of the wheel speed sensors. The wheel speed diagnostic module diagnoses amplitudes of the wheel speed pulse signals.

An ADC acquisition circuit is provided at a wheel speed pulse input interface and communicates with the wheel speed diagnostic module. The ADC acquisition circuit acquires wheel speed pulse signals from the one of the wheel speed sensors. The wheel speed diagnostic module diagnoses amplitudes of the wheel speed pulse signals. Upon the amplitudes of the wheel speed pulse signals falling within the preset amplitude range, the wheel speed signals output by the one of the wheel speed sensors are deemed valid.

Furthermore, the wheel speed pulse signals output by the wheel speed sensors are current-modulated signals or pulse width modulation signals.

Furthermore, the MCU integrates a wheel speed signal verification module which receives the valid wheel speed signals sent by the four wheel speed signal processing units and performs a verification process on the valid wheel speed signals.

The wheel speed signal verification module reads the valid wheel speed signals during steady driving and examines deviations between the valid wheel speed signals. Upon the deviations between one of the valid wheel speed signals and each of the remaining wheel speed signals exceeding a preset deviation threshold, the corresponding valid wheel speed signal is determined to be faulty.

Furthermore, the independent redundant wheel speed processing system further includes two MCUs: a main MCU and a secondary MCU.

Output terminals of the four wheel speed signal processing units are connected to the main MCU and the secondary MCU.

The main MCU and the secondary MCU respectively calculate first and second computed wheel speed signals of the wheel speed sensors based on valid wheel speed pulse signals output by a wheel speed signal verification module.

Furthermore, power supplies for the front wheel speed sensors are independently controlled by the main MCU, and power supplies for the rear wheel speed sensors are controlled by the main MCU or the secondary MCU.

Furthermore, during a power-on stage, the front wheel speed sensors and the rear wheel speed sensors are initially in a powered-on state. During operation and power-off stages, the power supplies for the front wheel speed sensors and the rear wheel speed sensors are controlled by the main MCU. The main MCU monitors a real-time operating status of each of the wheel speed sensors. Upon detection of a fault in one of the wheel speed sensors, the main MCU cuts off the power supply to the faulty wheel speed sensor without affecting the operation of the remaining wheel speed sensors.

Furthermore, upon the main MCU detecting a fault in one of the front wheel speed sensors, the main MCU cuts off the power supply to the faulty front wheel speed sensor. Upon the main MCU detecting a fault in one of the rear wheel speed sensors, the main MCU instructs the secondary MCU to cut off the power supply to the faulty rear wheel speed sensor when communication between the main MCU and the secondary MCU is normal, and the secondary MCU sends the result back to the main MCU after cutting off the power. Upon the main MCU detecting a fault in one of the rear wheel speed sensors, the power supplies to the rear wheel speed sensors are controlled by the secondary MCU when communication between the main MCU and the secondary MCU fails, and the secondary MCU can automatically cut off the power supply to the faulty rear wheel speed sensor.

Furthermore, the secondary MCU transmits the second computed wheel speed signals of the wheel speed sensors to the main MCU. Upon the first computed wheel speed signals and the second computed wheel speed signals matching, the main MCU is determined to be operating normally.

The present disclosure further provides an independent redundant wheel speed processing method. The method includes:

S1. collecting high-side voltage signals of the four wheel speed sensors and output signals from the acquisition circuits, performing high-side drive fault diagnoses on the wheel speed sensors based on the high-side voltage signals, and performing low-side drive diagnoses on the acquisition circuits based on the output signals of the acquisition circuits;

S2. upon a high-side drive fault or a low-side drive fault being verified, determining a corresponding wheel speed sensor fault; upon neither high-side drive fault nor low-side drive fault being verified in the wheel speed sensors, proceeding to step S3;

S3. detecting the validity of wheel speed information output by the wheel speed sensors, upon the wheel speed information being valid, proceeding to step S4; upon the wheel speed information being invalid, determining that both status and signal of the wheel speed sensor corresponding to invalid wheel speed information are faulty;

S4. Performing a verification process on valid wheel speed information by the MCU, upon detecting a failed wheel speed signal, determining that the wheel speed sensor corresponding to the failed wheel speed signal is faulty.

Furthermore, a method for performing the high-side drive fault diagnostic comprises providing an ADC sampling circuit on a high side of each of the wheel speed sensors to sample an ADC value of a voltage of the wheel speed sensor, and verifying an operating voltage corresponding to the sampled ADC value with a reference voltage output by the MCU to determine whether the operating voltage of the wheel speed sensor falls within a valid operating voltage range. Upon the operating voltage of the wheel speed sensor being within the valid operating voltage range, a high-side drive of the wheel speed sensor is deemed to be normal.

Furthermore, a method for performing low-side drive fault diagnostics comprises providing an acquisition circuit on a low side of each of the wheel speed sensors to acquire a low-side current signal, and performing a wheel speed open-circuit fault diagnosis and a wheel speed overcurrent fault diagnosis on output signals of the one of the wheel speed sensors based on the low-side current signal acquired by the corresponding acquisition circuit. When a low-side current remains below 2 mA for at least200 ms, a wheel speed open circuit is determined, thereby diagnosing a wheel speed open-circuit fault in the one of the wheel speed sensors. When the low-side current remains above 40mA for at least 200 ms, a wheel speed overcurrent is determined, thereby diagnosing a wheel speed overcurrent fault in the one of the wheel speed sensors.

Furthermore, a method for diagnosing the wheel speed signal abnormalities comprises providing a wheel speed pulse input interface for inputting wheel speed pulse signals from the one of the wheel speed sensors, providing an ADC acquisition circuit at the wheel speed pulse input interface to acquire the wheel speed pulse signals, and diagnosing amplitudes of the wheel speed pulse signals. Upon the amplitudes of the wheel speed pulse signals falling within a preset amplitude range, the wheel speed signals output by the one of the wheel speed sensors are deemed valid.

Furthermore, a method for performing the verification process on the valid wheel speed signals comprises reading the valid wheel speed signals during steady driving, and examining deviations between the valid wheel speed signals. Upon the deviations between one of the valid wheel speed signals and each of the remaining wheel speed signals exceeding a preset deviation threshold, the corresponding valid wheel speed signal is determined to be faulty.

The present disclosure ensures the functional safety and redundancy requirements of the braking system by providing independent and discrete wheel speed signal processing units, while also reducing the high costs incurred by using highly integrated chips to fulfill these requirements.

### BRIEF DESCRIPTION OF DRAWINGS

FIG. 1 is a block diagram of an existing wheel speed sensor interface hardware architecture.

FIG. 2 is a schematic structural diagram of an independent redundant wheel speed processing system with a single MCU according to an embodiment of the present disclosure.

FIG. 3 is a schematic structural diagram of a wheel speed processing unit of an independent redundant wheel speed processing system with a single MCU according to an embodiment of the present disclosure.

FIG. 4 is a schematic structural diagram of an ADC sampling circuit of an independent redundant wheel speed processing system according to an embodiment of the present disclosure.

FIG. 5 is a schematic structural diagram of an acquisition circuit of an independent redundant wheel speed processing system according to an embodiment of the present disclosure.

FIG. 6 is a schematic structural diagram of an ADC acquisition circuit of an independent redundant wheel speed processing system according to an embodiment of the present disclosure.

FIG. 7 is a schematic structural diagram of an independent redundant wheel speed processing system with dual MCUs according to an embodiment of the present disclosure.

FIG. 8 is a flowchart of an independent redundant wheel speed processing method according to an embodiment of the present disclosure.

### DETAILED DESCRIPTION

Specific embodiments of the present disclosure are described in detail below with reference to the accompanying drawings, to assist a person skilled in the art in gaining a more complete, accurate, and in-depth understanding of the inventive concept and technical solutions of the present disclosure.

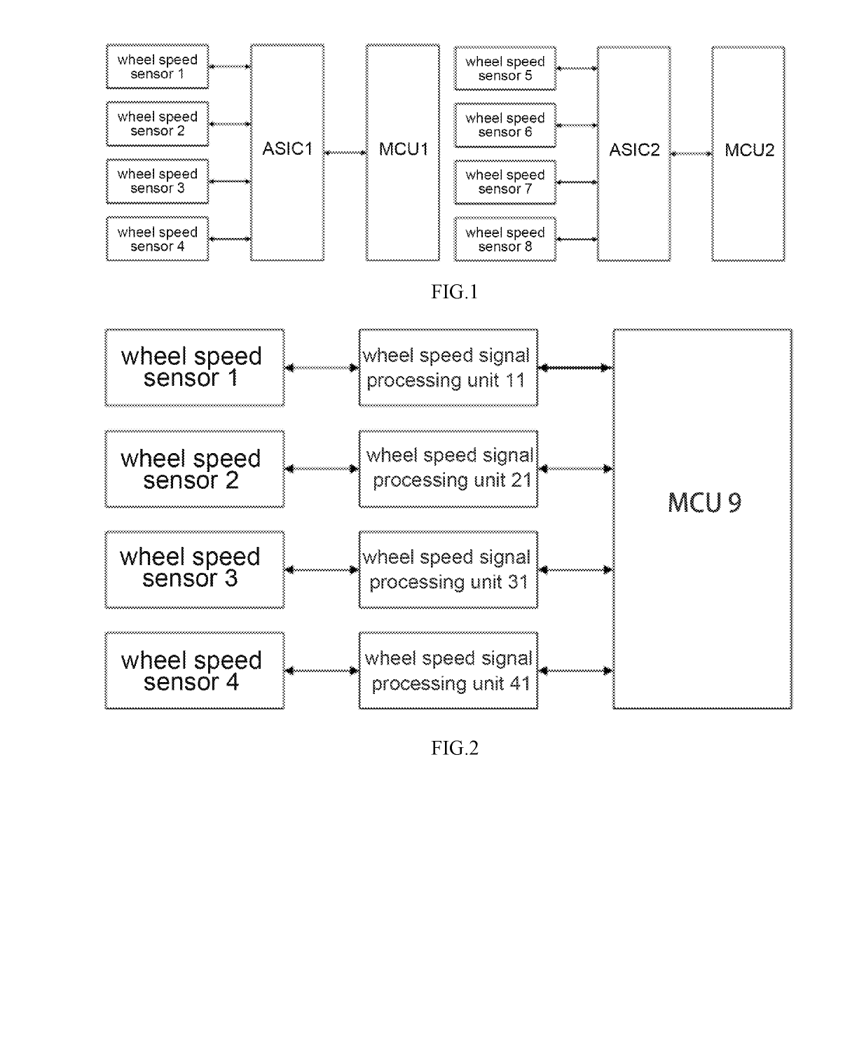

FIG. 2 is a schematic structural diagram of an independent redundant wheel speed processing system according to an embodiment of the present disclosure. For clarity, only the parts related to the embodiments of the present disclosure are shown. The independent redundant wheel speed processing system includes four wheel speed sensors 1,2,3,4 respectively disposed on four wheels.

The four wheel speed sensors 1,2,3,4 include a wheel speed sensor 1, a wheel speed sensor 2, a wheel speed sensor 3, and a wheel speed sensor 4. The four wheel speed sensors 1,2,3,4 are respectively in communication with an MCU 9 through four wheel speed signal processing units 11,21,31,41.

The four wheel speed signal processing units 11,21,31,41 respectively diagnose drive abnormalities and wheel speed signal abnormalities of the four wheel speed sensors 1,2,3,4, and send diagnostic results as well as wheel speed signals output by the wheel speed sensors 1,2,3,4 to the MCU 9.

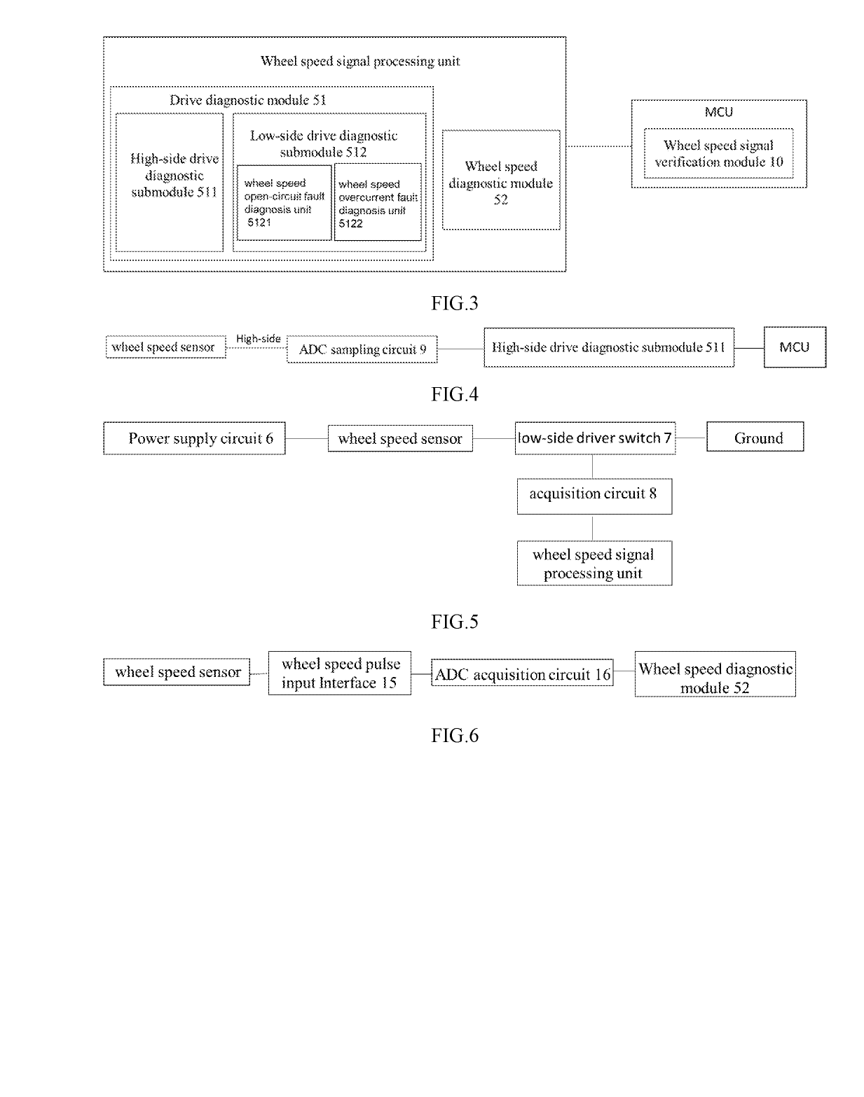

In the embodiments of the present disclosure, each of the wheel speed sensors 1,2,3,4 is connected to one of the wheel speed signal processing units 11,21,31,41. As shown in FIG. 3, each wheel speed signal processing unit 11,21,31,41 includes a drive diagnostic module 51 and a wheel speed diagnostic module 52. The drive diagnostic module 51 and the wheel speed diagnostic module 52 respectively diagnose the drive abnormalities and the wheel speed signal abnormalities of the corresponding wheel speed sensor, and then upload the diagnostic results to the MCU 9.

The drive diagnostic module 51 includes a high-side drive diagnostic submodule 511 and a low-side drive diagnostic submodule 512.

(1) The high-side drive diagnostic submodule 511 is connected to a high side of the one of the wheel speed sensors 1,2,3,4 and communicates with the MCU 9. The high-side drive diagnostic submodule 511 performs a high-side drive fault diagnosis on the corresponding wheel speed sensor based on a high-side voltage.

As shown in FIG. 4, an ADC sampling circuit 9 is provided on a high-side of the corresponding wheel speed sensor to sample an ADC value of the high-side voltage of the corresponding wheel speed sensor. The high-side drive diagnostic submodule 511 communicates with the ADC sampling circuit 9 to acquire the sampled ADC value and determines an operating voltage corresponding to the sampled ADC value. The high-side drive diagnostic submodule 511 acquires a reference voltage from the MCU 9 to verify with the operating voltage, thereby determining whether the operating voltage of the wheel speed sensor falls within a valid operating voltage range. If the operating voltage of the corresponding wheel speed sensor is within the valid operating voltage range, a high-side drive of the corresponding wheel speed sensor is considered to be normal.

(2) The low-side drive diagnostic submodule 512 is connected to a low side of the one of the wheel speed sensors 1,2,3,4 through an acquisition circuit 8. The low-side drive diagnostic submodule 512 performs a low-side drive fault diagnosis on the corresponding wheel speed sensor based on output information of the acquisition circuit 8.

The independent redundant wheel speed processing system further includes four power supply circuits 6 which supply power to the four wheel speed sensors 1,2,3,4, and four acquisition circuits 8 which collect signals from the four wheel speed sensors 1,2,3,4. If one of the acquisition circuits 8 or power supply circuits 6 is faulty, the power supply and signal acquisition for the remaining three wheel speed sensors 1,2,3,4 remain unaffected.

FIG. 5 is a schematic structural diagram of an acquisition circuit of an independent redundant wheel speed processing system according to an embodiment of the present disclosure. Specifically, during vehicle operation, low-side switches 7 of the wheel speed sensors 1,2,3,4 are in the ON state, forming a complete wheel speed sensor power circuit, and the low-side drive diagnostic submodule 512 of each of the wheel speed signal processing unit 11,21,31,41 performs wheel speed signal processing. The low-side drive diagnostic submodule 512 includes a wheel speed open-circuit fault diagnosis unit 5121 and a wheel speed overcurrent fault diagnosis unit 5122. The wheel speed open-circuit fault diagnosis unit 5121 and the wheel speed overcurrent fault diagnosis unit 5122 communicate with the acquisition circuit 8 and perform fault diagnosis on output signals of the respective wheel speed sensors 1,2,3,4 based on the acquisition circuit 8. In some embodiments, wheel speed open-circuit fault diagnosis unit 5121 and the wheel speed overcurrent fault diagnosis unit 5122 detect a low-side current signal. When a low-side current remains below 2 mA for at least 200 ms, a wheel speed open circuit is determined, thereby diagnosing a wheel speed open-circuit fault in the corresponding wheel speed sensor. When the low-side current remains above 40mA for at least 200 ms, a wheel speed overcurrent is determined, thereby diagnosing a wheel speed overcurrent fault in the corresponding wheel speed sensor.

Whether the acquisition circuits 8 are faulty is diagnosed by the low-side drive diagnostic submodule 512, and four low-side drive diagnostic submodules 512 are provided to correspond to the four wheel speed sensors 1,2,3,4.

(3) The wheel speed diagnostic module 52 performs a wheel speed signal diagnostic.

As shown in FIG. 6, a wheel speed pulse input interface 15 is provided for inputting wheel speed pulse signals from the corresponding wheel speed sensor, and an ADC acquisition circuit 16 is provided at the wheel speed pulse input interface 15 to sample the wheel speed pulse signals. Amplitudes of the wheel speed pulse signals are then diagnosed to determine whether the amplitudes fall within a preset amplitude range. If the amplitudes of the wheel speed pulse signals fall within the preset amplitude range, the wheel speed signals output by the corresponding wheel speed sensor are deemed valid, and a pulse drive of the corresponding wheel speed sensor is deemed normal.

In the embodiments of the present disclosure, the MCU 9 integrates a wheel speed signal verification module 10, which receives the valid wheel speed signals sent by the four wheel speed signal processing units 11,21,31,41 and performs a verification process on the valid wheel speed signals. Specifically, the verification process includes reading the valid wheel speed signals during steady driving and examining deviations between the valid wheel speed signals. A wheel speed signal is deemed invalid if the deviation between the wheel speed signal and each of the remaining wheel speed signals exceeds a preset threshold, indicating that the wheel speed sensor signal is not an actual wheel speed signal, but an invalid signal.

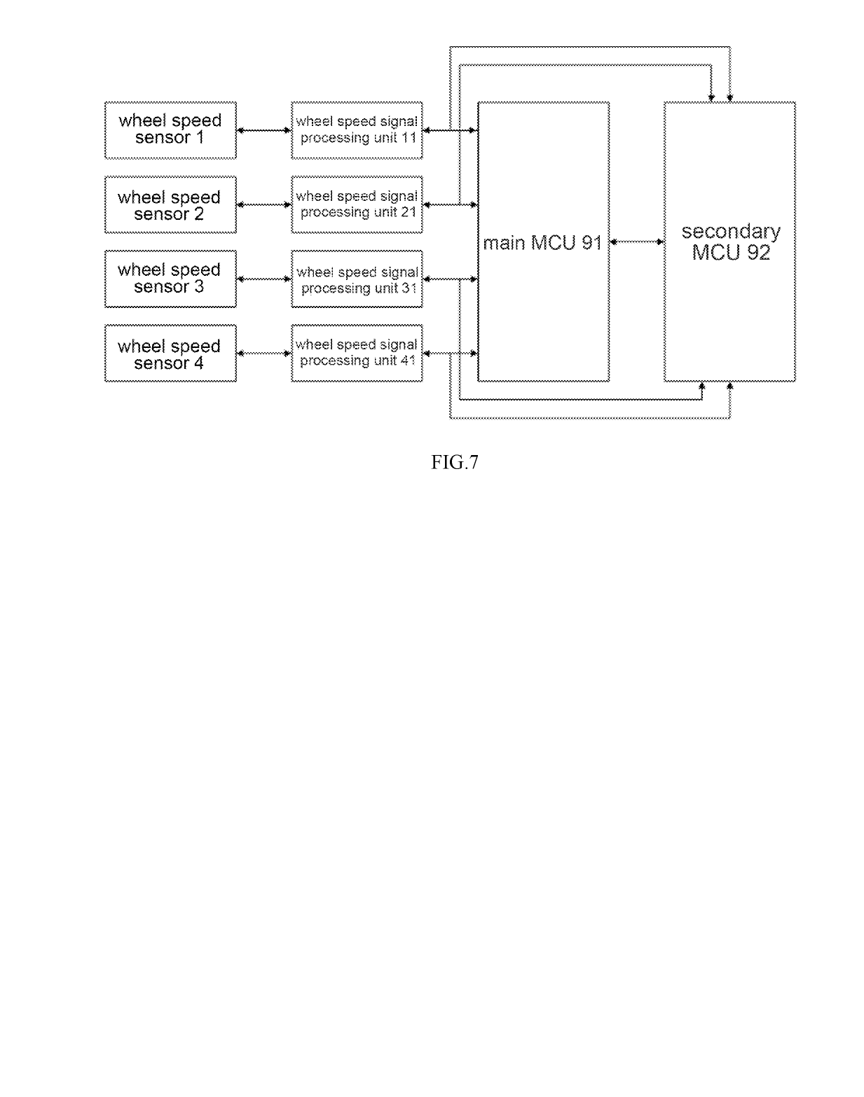

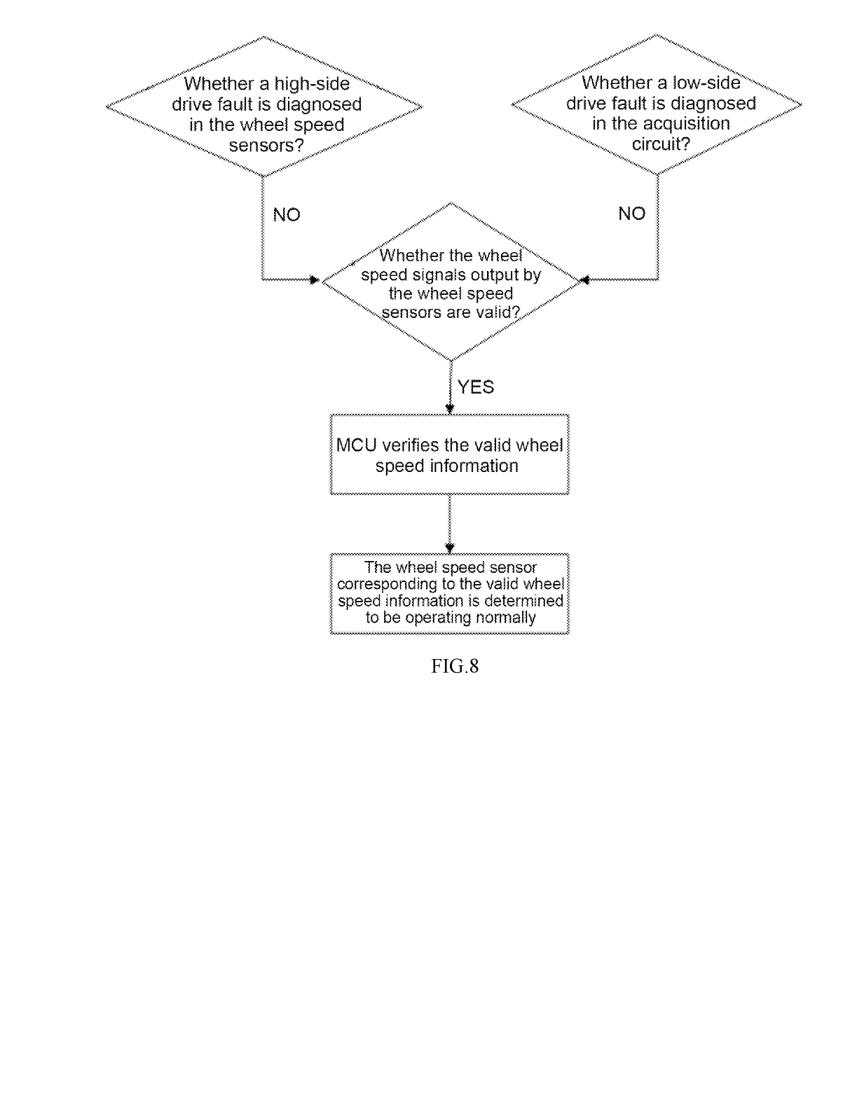

FIG. 7 is a schematic structural diagram of an independent redundant wheel speed processing system with dual MCUs according to an embodiment of the present disclosure. For clarity, only the parts related to the embodiments of the present disclosure are shown. The independent redundant wheel speed processing system includes two MCUs: a main MCU 91 and a secondary MCU 92.

Output terminals of the four wheel speed signal processing units 11,21,31,41 are connected to the main MCU 91 and the secondary MCU 92.

The main MCU 91 calculates first computed wheel speed signals of the wheel speed sensors 1,2,3,4 based on valid wheel speed pulse signals output by the wheel speed signal verification module 10.

The secondary MCU 92 calculates second computed wheel speed signals of the wheel speed sensors 1,2,3,4 and simultaneously acquires speed directions of the wheel speed sensors 1,2,3,4 based on the valid wheel speed pulse signals output by the wheel speed signal verification module 10. The second computed wheel speed signals and the speed directions are then transmitted to the main MCU 91 for verification. If the first and second computed wheel speed signals match, the main MCU 91 is determined to be operating normally.

In embodiments of the present disclosure, the wheel speed pulse signals output by the wheel speed sensors 1,2,3,4 can be current-modulated signals or pulse width modulation (PWM) signals, and are not specifically limited herein. When the wheel speed sensors 1,2,3,4 output current-modulated signals, the detected valid wheel speed pulse signals are first processed by secondary MCU 92, and speed-direction information is fed back to the main MCU 91 via a serial port. When the wheel speed sensors 1,2,3,4 output the PWM signals, the detected valid wheel speed pulse signals are processed by the main MCU 91 itself.

In the embodiments of the present disclosure, the abundance of speed-direction information, including vehicle forward, backward and stationary status information, enables the secondary MCU 92 to continue to process the valid wheel speed pulse signals output the wheel speed signal verification module 10, and transmit processed wheel speed signals to an electronic control unit that requires the wheel speed signals via a CAN interface when the main MCU 91 is faulty and the secondary MCU 92 operates normally. In an embodiment of the present disclosure, power supplies for the front wheel speed sensors 1,2 are independently controlled by the main MCU 91, and power supplies for the rear wheel speed sensors 3,4 are controlled by the main MCU 91 or the secondary MCU 92.

The following describes the different operating stages of the independent redundant wheel speed processing system.

During a power-on stage, the front wheel speed sensors 1,2 and the rear wheel speed sensors 3,4 are initially in a powered-on state. At this time, the wheel speed switch control pins of the main MCU 91 and secondary MCU 92 do not need to be pulled low to maintain the power supply.

During operation and power-off stages, the power supplies for the front wheel speed sensors 1,2 and the rear wheel speed sensors 3,4 are controlled by the main MCU 91. The main MCU 91 monitors a real-time operating status of each of the wheel speed sensors 1,2,3,4. Upon detection of a fault in one of the wheel speed sensors 1,2,3,4, the main MCU 91 cuts off the power supply to the faulty wheel speed sensor without affecting the operation of the remaining wheel speed sensors. Specifically, upon the main MCU 91 detecting a fault in one of the front wheel speed sensors 1,2, it cuts off the power supply to the faulty front wheel speed sensor. Upon the main MCU 91 detecting a fault in one of the rear wheel speed sensors 3,4, the main MCU 91 instructs the secondary MCU 92 to cut off the power supply to the faulty rear wheel speed sensor when communication between the main MCU 91 and the secondary MCU 92 is normal. After cutting off the power, the secondary MCU 92 sends the result back to the main MCU 91. When communication between the main MCU 91 and the secondary MCU 92 fails, the power supplies to the rear wheel speed sensors 3,4 are controlled by the secondary MCU 92. In this case, the secondary MCU 92 can automatically cut off the power supply to the faulty rear wheel speed sensor. Since the main MCU 91 is faulty, the secondary MCU 92 can detect the real-time operating status of each of the wheel speed sensors 1,2,3,4, achieving redundant response.

The independent redundant wheel speed processing system provided by the present disclosure has the following beneficial technical effects.

(1) The present disclosure replaces high-integration chips with four independent wheel speed signal processing units 11,21,31,41 to collect wheel speed signals. From a functional safety perspective, the present disclosure not only ensures the validity and synchronization of the wheel speed signals, but also meets the independence requirements by using software algorithms to diagnose the wheel speed signals and filtering out the correlation interference between the wheel speed signals through the four independent signal paths. The present disclosure provides a safety mechanism design that complies with functional safety standards, enhancing the speed and accuracy of wheel speed signal fault diagnosis. In the event of a functional downgrade, fault information is transmitted to the HMI, which is then displayed on the instrument panel to alert the driver, ensuring the system enters a safe state. (2) From a functional redundancy perspective, four wheel speed sensor interfaces are connected to four independent sensor circuits, with the corresponding wheel speed signals processed redundantly by two MCUs. Even if one wheel speed sensor or acquisition circuit fails, the signals from the remaining three wheel speed sensors remain valid. Even if one MCU fails, the validity of the four wheel speed signals is still ensured. The present disclosure not only meets the functional safety and redundancy requirements of the braking system but also reduces the overall cost of the vehicle's brake electronic control unit system.

FIG. 8 is a flowchart of an independent redundant wheel speed processing method according to an embodiment of the present disclosure. The method specifically includes the following steps:

S1. collecting high-side voltage signals of the four wheel speed sensors 1,2,3,4 and output signals from the acquisition circuits, performing high-side drive fault diagnoses on the wheel speed sensors 1,2,3,4 based on the high-side voltage signals, and performing low-side drive fault diagnoses on the acquisition circuits based on the output signals of the acquisition circuits;

S2. upon a high-side drive fault or a low-side drive fault being verified, determining a corresponding wheel speed sensor fault; upon neither high-side drive fault nor low-side drive fault being verified in the wheel speed sensors 1,2,3,4, proceeding to step S3;

S3. detecting the validity of wheel speed information output by the wheel speed sensors 1,2,3,4, upon the wheel speed information being valid, proceeding to step S4; upon the wheel speed information being invalid, determining that both status and signal of the wheel speed sensor corresponding to invalid wheel speed information are faulty;

S4. performing a verification process on valid wheel speed information by the MCU 9, upon detecting a failed wheel speed signal, determining that the wheel speed sensor corresponding to the failed wheel speed signal is faulty.

A method for performing the high-side drive fault diagnostic includes providing an ADC sampling circuit 9 on a high side of each of the wheel speed sensors 1,2,3,4 to sample an ADC value of a voltage of the wheel speed sensor, and verifying an operating voltage corresponding to the sampled ADC value with a reference voltage output by the MCU 9 to determine whether the operating voltage of the wheel speed sensor falls within a valid operating voltage range. Upon the operating voltage of the wheel speed sensor being within the valid operating voltage range, a high-side drive of the wheel speed sensor is deemed to be normal.

A method for performing low-side drive fault diagnostics includes providing an acquisition circuit 8 on a low side of each of the wheel speed sensors 1,2,3,4 to acquire a low-side current signal, and performing a wheel speed open-circuit fault diagnosis and a wheel speed overcurrent fault diagnosis on output signals of the one of the wheel speed sensors 1,2,3,4 based on the low-side current signal acquired by the corresponding acquisition circuit 8. When a low-side current remains below 2 mA for at least 200 ms, a wheel speed open circuit is determined, thereby diagnosing a wheel speed open-circuit fault in the one of the wheel speed sensors 1,2,3,4. When the low-side current remains above 40mA for at least 200 ms, a wheel speed overcurrent is determined, thereby diagnosing a wheel speed overcurrent fault in the one of the wheel speed sensors 1,2,3,4.

A method for diagnosing the wheel speed signal abnormalities includes providing a wheel speed pulse input interface 15 for inputting wheel speed pulse signals from the one of the wheel speed sensors 1,2,3,4, providing an ADC acquisition circuit 16 at the wheel speed pulse input interface 15 to acquire the wheel speed pulse signals, and diagnosing amplitudes of the wheel speed pulse signals. Upon the amplitudes of the wheel speed pulse signals falling within a preset amplitude range, the wheel speed signals output by the one of the wheel speed sensors 1,2,3,4 are deemed valid.

A method for performing the verification process on the valid wheel speed signals includes reading the valid wheel speed signals during steady driving, and examining deviations between the valid wheel speed signals. Upon the deviations between one of the valid wheel speed signals and each of the remaining wheel speed signals exceeding a preset deviation threshold, the corresponding valid wheel speed signal is determined to be faulty.

The present disclosure has been described by way of example, and it is apparent that the specific implementation of the present disclosure is not limited to the described embodiments. Any non-substantial improvements made based on the conceptual approach and technical solutions of the present disclosure, or the direct application of the concept and technical solutions of the present disclosure to other scenarios without modification, are all within the scope of protection of the present disclosure.

1. An independent redundant wheel speed processing system, comprising:
four wheel speed sensors (1,2,3,4) respectively disposed on four wheels; and
four wheel speed signal processing units (11,21,31,41), wherein the four wheel speed sensors (1,2,3,4) are respectively in communication with an MCU (9) through the four wheel speed signal processing units (11,21,31,41);
wherein each of the four wheel speed signal processing units (11,21,31,41) diagnoses drive abnormalities and wheel speed signal abnormalities of one of the four wheel speed sensors (1,2,3,4), and transmits diagnostic results as well as valid wheel speed signals output by the one of the wheel speed sensors (1,2,3,4) to the MCU (9).

2. The system according to claim 1, wherein each of the four wheel speed signal processing units (11,21,31,41) comprises a drive diagnostic module (51) which diagnoses the drive abnormalities of the one of the wheel speed sensors (1,2,3,4), wherein the drive diagnostic module (51) comprises a high-side drive diagnostic submodule (511) and a low-side drive diagnostic submodule (512);
wherein the high-side drive diagnostic submodule (511) is connected to a high side of the one of the wheel speed sensors (1,2,3,4) and communicates with the MCU (9), wherein the high-side drive diagnostic submodule (511) performs a high-side drive fault diagnosis on the one of the wheel speed sensors (1,2,3,4) based on a high-side voltage;
wherein the low-side drive diagnostic submodule (512) is connected to a low side of the one of the wheel speed sensors (1,2,3,4) through an acquisition circuit (8), wherein the low-side drive diagnostic submodule (512) performs a fault diagnosis on output signals of the one of the wheel speed sensors (1,2,3,4) based on the acquisition circuit (8), wherein the acquisition circuit (8) and a power supply circuit (6) are independently connected to the one of the wheel speed sensors (1,2,3,4), wherein the power supply circuit (6) provides power to the one of the wheel speed sensors (1,2,3,4), and the acquisition circuit (8) acquires wheel speed signals.

3. The system according to claim 2, wherein the low-side drive diagnostic submodule (512) comprises a wheel speed open-circuit fault diagnosis unit (5121) and a wheel speed overcurrent fault diagnosis unit (5122), wherein the wheel speed open-circuit fault diagnosis unit (5121) and the wheel speed overcurrent fault diagnosis unit (5122) communicate with the acquisition circuit (8) and perform fault diagnosis on output signals of the one of the wheel speed sensors (1,2,3,4) based on a low-side current signal acquired by the acquisition circuit (8),
wherein, when a low-side current remains below 2 mA for at least 200 ms, a wheel speed open circuit is determined, thereby diagnosing a wheel speed open-circuit fault in the one of the wheel speed sensors (1,2,3,4),
wherein, when the low-side current remains above 40mA for at least 200 ms, a wheel speed overcurrent is determined, thereby diagnosing a wheel speed overcurrent fault in the one of the wheel speed sensors (1,2,3,4).

4. The system according to claim 2, further comprising an ADC sampling circuit (9) on a high side of each of the wheel speed sensors (1,2,3,4) to sample an ADC value of a voltage of the respective wheel speed sensor, wherein the high-side drive diagnostic submodule (511) communicates with the ADC sampling circuit (9) to acquire the sampled ADC value and determines an operating voltage corresponding to the sampled ADC value, wherein the high-side drive diagnostic submodule (511) acquires a reference voltage from the MCU (9) to verify with the operating voltage, thereby determining whether the operating voltage of the respective wheel speed sensor falls within a valid operating voltage range,
wherein, upon the operating voltage of one of the wheel speed sensors (1,2,3,4) being within the valid operating voltage range, a high-side drive of the one of the wheel speed sensors (1,2,3,4) is deemed to be normal.

5. The system according to claim 1, wherein each of the wheel speed signal processing units (11,21,31,41) comprises a wheel speed diagnostic module (52) which diagnoses the wheel speed signal abnormalities, wherein an ADC acquisition circuit (16) is provided at a wheel speed pulse input interface (15) and communicates with the wheel speed diagnostic module (52), wherein the ADC acquisition circuit (16) acquires the wheel speed pulse signals from the one of the wheel speed sensors (1,2,3,4), wherein the wheel speed diagnostic module (52) diagnoses amplitudes of the wheel speed pulse signals,:
wherein, upon the amplitudes of the wheel speed pulse signals falling within a preset amplitude range, the wheel speed signals output by the one of the wheel speed sensors (1,2,3,4) are deemed valid.

6. The system according to claim 5, wherein the wheel speed pulse signals output by the wheel speed sensors (1,2,3,4) are current-modulated signals or pulse width modulation signals.

7. The system according to claim 1, wherein the MCU (9) integrates a wheel speed signal verification module (10) which receives the valid wheel speed signals sent by the four wheel speed signal processing units (11,21,31,41) and performs a verification process on the valid wheel speed signals.

8. The system according to claim 7, wherein the wheel speed signal verification module (10) reads the valid wheel speed signals during steady driving and examines deviations between the valid wheel speed signals:
wherein, upon the deviations between one of the valid wheel speed signals and each of the remaining wheel speed signals exceeding a preset deviation threshold, the corresponding valid wheel speed signal is determined to be faulty.

9. The system according to claim 1, further comprising:
two MCUs, wherein the two MCUs comprise a main MCU (91) and a secondary MCU (92), wherein output terminals of the four wheel speed signal processing units (11,21,31,41) are connected to the main MCU (91) and the secondary MCU (92);
wherein the main MCU (91) and the secondary MCU (92) respectively calculate first and second computed wheel speed signals of the wheel speed sensors (1,2,3,4) based on valid wheel speed pulse signals output by a wheel speed signal verification module.

10. The system according to claim 9, wherein:
the secondary MCU (92) transmits the second computed wheel speed signals of the wheel speed sensors (1,2,3,4) to the main MCU (91), upon the first computed wheel speed signals and the second computed wheel speed signals matching, the main MCU (91) is determined to be operating normally.

11. The system according to claim 9, wherein power supplies for the front wheel speed sensors (1,2) are independently controlled by the main MCU (91), and power supplies for the rear wheel speed sensors (3,4) are controlled by the main MCU (91) or the secondary MCU (92).

12. The system according to claim 11, wherein, during a power-on stage, the front wheel speed sensors (1,2) and the rear wheel speed sensors (3,4) are initially in a powered-on state,
wherein, during operation and power-off stages, the power supplies for the front wheel speed sensors (1,2) and the rear wheel speed sensors (3,4) are controlled by the main MCU (91), wherein the main MCU (91) monitors a real-time operating status of each of the wheel speed sensors (1,2,3,4), and upon detection of a fault in one of the wheel speed sensors (1,2,3,4), the main MCU (91) cuts off the power supply to the faulty wheel speed sensor without affecting the operation of the remaining wheel speed sensors.

13. The system according to claim 12, wherein, upon the main MCU (91) detecting a fault in one of the front wheel speed sensors (1,2), the main MCU (91) cuts off the power supply to the faulty front wheel speed sensor,
wherein, upon the main MCU (91) detecting a fault in one of the rear wheel speed sensors (3,4), the main MCU (91) instructs the secondary MCU (92) to cut off the power supply to the faulty rear wheel speed sensor when communication between the main MCU (91) and the secondary MCU (92) is normal, and the secondary MCU (92) sends the result back to the main MCU (91) after cutting off the power,
wherein, upon the main MCU (91) detecting a fault in one of the rear wheel speed sensors (3,4), the power supplies to the rear wheel speed sensors (3,4) are controlled by the secondary MCU (92) when communication between the main MCU (91) and the secondary MCU (92) fails, and the secondary MCU (92) can automatically cut off the power supply to the faulty rear wheel speed sensor.

14. An independent redundant wheel speed processing method based on the independent redundant wheel speed processing system according to claim 1, comprising:
1S. collecting high-side voltage signals of the four wheel speed sensors (1,2,3,4) and output signals from the acquisition circuits (8), performing high-side drive fault diagnoses on the wheel speed sensors (1,2,3,4) based on the high-side voltage signals, and performing low-side drive fault diagnoses on the acquisition circuits (8) based on the output signals of the acquisition circuits (8);
2S. upon a high-side drive fault or a low-side drive fault being verified, determining a corresponding wheel speed sensor fault; upon neither high-side drive fault nor low-side drive fault being verified in the wheel speed sensors (1,2,3,4), proceeding to step S3;
3S. detecting the validity of wheel speed information output by the wheel speed sensors (1,2,3,4), upon the wheel speed information being valid, proceeding to step S4; upon the wheel speed information being invalid, determining that both status and signal of a corresponding wheel speed sensor are faulty;
4S. performing a verification process on valid wheel speed information by the MCU (9), upon detecting a failed wheel speed signal, determining a corresponding wheel speed sensor is faulty.

15. The processing method according to claim 14, wherein a method for performing the high-side drive fault diagnoses comprises:
providing an ADC sampling circuit (16) on a high side of each of the wheel speed sensors (1,2,3,4) to sample an ADC value of a voltage of the respective wheel speed sensor, verifying an operating voltage corresponding to the sampled ADC value with a reference voltage output by the MCU (9) to determine whether the operating voltage of the respective wheel speed sensor falls within a valid operating voltage range, upon the operating voltage of one of the wheel speed sensors (1,2,3,4) being within the valid operating voltage range, a high-side drive of the one of the wheel speed sensor (1,2,3,4) is deemed to be normal.

16. The processing method according to claim 14, wherein a method for performing low-side drive fault diagnoses comprises:
providing an acquisition circuit (8) on a low side of each of the wheel speed sensors (1,2,3,4) to acquire a low-side current signal, and performing a wheel speed open-circuit fault diagnosis and a wheel speed overcurrent fault diagnosis on output signals of the one of the wheel speed sensors (1,2,3,4) based on the low-side current signal acquired by the corresponding acquisition circuit (8),
wherein, when a low-side current remains below 2 mA for at least 200 ms, a wheel speed open circuit is determined, thereby diagnosing a wheel speed open-circuit fault in the one of the wheel speed sensors (1,2,3,4),
wherein, when the low-side current remains above 40mA for at least 200 ms, a wheel speed overcurrent is determined, thereby diagnosing a wheel speed overcurrent fault in the one of the wheel speed sensors (1,2,3,4).

17. The processing method according to claim 14, wherein a method for diagnosing the wheel speed signal abnormalities comprises:
providing a wheel speed pulse input interface (15) for inputting wheel speed pulse signals from the one of the wheel speed sensors (1,2,3,4), providing an ADC acquisition circuit (16) at the wheel speed pulse input interface to acquire the wheel speed pulse signals, diagnosing amplitudes of the wheel speed pulse signals, upon the amplitudes of the wheel speed pulse signals falling within a preset amplitude range, the wheel speed signals output by the one of the wheel speed sensors (1,2,3,4) are deemed valid.

18. The processing method according to claim 14, wherein a method for performing the verification process on the valid wheel speed signals comprises:
reading the valid wheel speed signals during steady driving, examining deviations between the valid wheel speed signals, and determining the corresponding valid wheel speed signal to be faulty when the deviations between one of the valid wheel speed signals and each of the remaining wheel speed signals exceed a preset deviation threshold.
